(19) United States
(12) Patent Application Publication
(10) Pub. No.: US 2005/0016910 A1
(43) Pub. Date: Jan. 27, 2005

(54) Waste water filtering and recycling system

(76) Inventor: Gabriel Plante, St-Lambert (CA)

Correspondence Address: Mr. Gabriel Plante, 1437 des Erables, St-Lambert, QC, GOS 2WO, CA

(21) Appl. No.: 10/601,292

(22) Filed: Jun. 23, 2003

(51) Int. Cl. C02F 9/00

(52) U.S. Cl. 210/194

(57) ABSTRACT

The present invention is a system being used for filtering and recycling the waste water collected and stored in a recuperating tank, and which a pump moves the waste water out of the recuperating tank via a water outlet with valve and a recuperating return line through a liquid filtration system, a ground water filter, a separator that separates oil from the water for it directing via a conduit and through a main drain, and thereafter discharged into a conventional septic tank or municipal sewage. Furthermore, the recycled water circulating through separator is directed via a second pump for keeping the water pressure through a fading water filter, a recycled water line for supplying a tank transferring water via a toilet and laundry, and through from the recycled water feeding system. The recycled water being used for flushing toilet will be directed toward a conduit via the main drain, and thereafter discharged into the conventional septic tank or municipal sewage.

### BACKGROUND OF THE INVENTION

1. Field of the Invention

This invention relates to a system being used for filtering and recycling the waste water collected and stored in a recuperating tank, and which the recycled water is reused for supplying plumbing fixtures, and more particularly for utilization in a commercial building.

2. Description of the Related Art

A search of prior art records has unveiled the following patents:

1. U.S. Pat. No.5,950,643 issued in 1999 to Miyazaki;

2. U.S. Pat. No.5,718,015 issued in 1998 to Rohrbacher;

3. U.S. Pat. No.5,272,091 issued in 1993 to Egozy;

4. U.S. Pat. No.5,173,180 issued in 1992 to Stewart;

5. U.S. Pat. No.5,004,536 issued in 1991 to Geisler;

6. U.S. Pat. No.4,769,154 issued in 1988 to Saylor;

7. U.S. Pat. No.4,219,515 issued in 1980 to Helser;

8. CA 2,234,466 registered in 1998 to Lucenet;

9. CA 2,298,079 registered in 2000 to Weyrauch;

10. CA 2,204,192 issued in 1999 to Tremblay; and

11. CA 2,324,509 registered in 2000 to Aquarecycle inc.

As can be seen the patents mentioned above are probably the most relevant.

It is well known that the reuse of process and waste water becomes more and more interesting because:
The cost of tap water is constantly increasing while concessions for the extraction of ground water are rarely granted anymore. It is expected that the price of drinking water will soon double in price;
Many industrial processes require heated or cooled process water. By reusing process water, the energy requirement demands are lowered and therefore savings can be made on your energy expenses;
When preparing process water, certain elements are removed to increase the performance of the system, while other substances are added to improve the water quality and promote the effectiveness of the process; When this water is reused, it is free of unwanted elements and already contains those elements which are needed by the process, therefore lowering costs;
Stricter demands are being made on the quality of the water flowing through processes. Disinfection by means of environmentally friendly products are highly recommended. Lenntech does not use chemicals for disinfecting purposes. Instead, Lenntech applies UV light and ozone which are very effective, yet harmless for the environment; and
The costs of draining off wastewater has risen by 20% in the past 5 years. These costs are expected to rise even more. Some companies have already placed pre-treatment units for treating wastewater. In many cases post-treatment of the water is also possible, therefore making it suitable for reuse in the process. The effluent can also undergo a less effective treatment and can be used as cooling or cleaning water. When none of the reuse options are chosen, Lenntech provides alternative methods of treating the effluent before draining. In this way the drainage tariffs are lowered.

It is, accordingly, a general object of this invention to provide a system being used for filtering and recycling the waste water collected and stored in a recuperating tank, and which the recycled water is reused for supplying plumbing fixtures, and more particularly for utilization in a commercial building.

### SUMMARY OF THE INVENTION

The system described in this invention will serve for filtering and recycling the waste water collected and stored in a recuperating tank, and which a pump moves the waste water out of the recuperating tank via a water outlet with valve and a recuperating return line through a liquid filtration system, a ground water filter, a separator that separates oil from the water for directing it via a conduit and through a main drain, and thereafter discharged into a conventional septic tank or municipal sewage.

The recycled water circulating through separator is directed via a second pump for keeping the water pressure through a fading water filter, a recycled water line for supplying a tank transferring water via a toilet and laundry, and through the recycled water feeding system.

The recycled water being used for flushing toilet will be directed toward a conduit via the main drain, and thereafter discharged into the conventional septic tank or municipal sewage.

Furthermore, the recycled and filtered water circulating through the recuperating return line is directed via a sterilizer before to be pre-heated in turning around a heater tank which is supplied thereby this recuperating return line, and thereafter the recycled water is directed via a recycled hot water line and through each water inlet with valve supplying each sink, a shower and tub, and a dishwasher through a booster raising the water temperature when needed for dishwashing.

The recuperating tank has a threaded cap and a conduit with valve for enabling the cleaning operation and draining the surplus of body wastes accumulated onto the walls and in bottom of the recuperating tank via the main drain, and thereafter discharged into the conventional septic tank or municipal sewage.

A cold water line coupled to a municipal water entering or artesian well, is directed via each water inlet with valve for supplying when needed each sink, a shower and tub, or enabling shut off water for maintenance or reparation.

The recuperating tank includes also an overflow line for removing the surplus of waste water from the recuperating thank via the main drain, and thereafter discharged into the conventional septic tank and municipal sewage.

### BRIEF DESCRIPTION OF THE SEVERAL VIEWS OF THE DRAWING(S)

FIG. 1 is a flow diagram of a waste water filtering and recycling system.

### DETAILED DESCRIPTION OF THE INVENTION

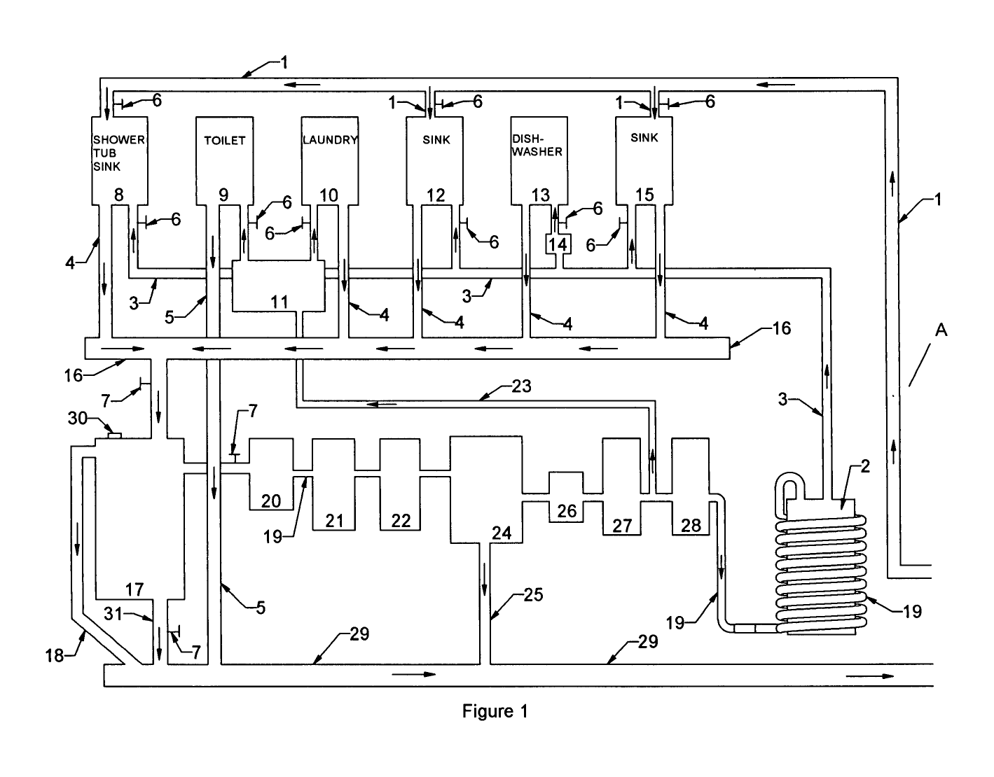

Referring now to FIG. 1, a system (A) being used for filtering and recycling the waste water collected and stored in a recuperating tank, and which the recycled water is reused for supplying plumbing fixtures, and more particularly in a commercial building.

The waste water circulating through from each sink, a dishwasher, a laundry, a shower and tub, is directed via each recuperating drain (4) and a recuperating line (16) through a water inlet with valve (7) via a recuperating tank (17) for receiving and storing the waste water.

A pump (20) moves the waste water out of the recuperating tank (17) via a water outlet with valve (7) and a recuperating return line (19) through a liquid filtration system (21), a ground water filter (22), a separator (24) that separates oil from the water for directing it via a conduit (25) and through a main drain (29), and thereafter discharged into a conventional septic tank or municipal sewage.

The recycled water circulating through separator (24) is directed via a second pump (26) for keeping the water pressure through a fading water filter (27), a recycled water line (23) for supplying a tank (11) transferring water via a toilet (9) and laundry (10), and through the recycled water feeding system.

The recycled water being used for flushing toilet (9) will be directed toward a conduit (5) via the main drain (29), and thereafter discharged into the conventional septic tank or municipal sewage.

Furthermore, the recycled and filtered water circulating through the recuperating return line (19) is directed via a sterilizer (28) before to be pre-heated in turning around a heater tank (2) which is supplied thereby this recuperating return line (19), and thereafter the recycled water is directed via a recycled hot water line (3) and through each water inlet with valve (6) supplying the sinks (8)(12)(15), shower and tub (8), and dishwasher (13) through a booster (14) raising the water temperature when needed for dishwashing.

The recuperating tank (17) has a threaded cap (30) and a conduit (31) with valve (7) for enabling the cleaning operation and draining the surplus of body wastes accumulated onto the walls and in bottom of the recuperating tank (17) via the main drain (29), and thereafter discharged into the conventional septic tank or municipal sewage.

A cold water line (1) coupled to a municipal water entering or artesian well, is directed via each water inlet with valve (6) for supplying when needed the sinks (8)(12)(15), shower and tub (8), or enabling shut off water for maintenance or reparation.

The recuperating tank (17) includes also an overflow line (18) for removing the surplus of waste water from the recuperating thank (17) via the main drain (29), and thereafter discharged into the conventional septic tank and municipal sewage.

Although only a single embodiment of the present invention has been described and illustrated, the present invention is not limited to the features of this embodiment, but includes all variations and modifications within the scope of claims attached hereto without departing from the spirit of the invention.

Legend:

1: Cold water line
2: Heater Tank
3: Recycled hot water line
4: Recuperating drain
5: Conduit
6: Valve
7: Valve
8: Shower, tub and sink
9: Toilet
10: Laundry
11: Transfer tank
12: Sink
13: Dishwasher
14: Booster
15: Sink
16: Recuperating line
17: Recuperating tank
18: Overflow line
19: Recuperating return line
20: First pump
21: Liquid filtration system
22: Ground water filter
23: Recycled water line
24: Oil/water separator
25: Conduit
26: Second pump
27: Fading water filter
28: Sterilizer
29: Main drain
30: Threaded cap
31: Conduit

1: A system being used for filtering and recycling the waste water, which comprising:
a cold water line coupled to a municipal water entering or artesian well, and which the cold water is directed via each water inlet with valve for supplying when needed each sink, a shower and tub;
and each valve can be closed for maintenance or reparation.

2: The waste water circulating through from the sinks, a dishwasher, a laundry, the shower and tub, is directed via each recuperating drain and a recuperating line through a water inlet with valve via a recuperating tank for receiving and storing the waste water.

3: A pump moves the waste water out of said recuperating tank via a water outlet with valve and a recuperating return line through a liquid filtration system, a ground water filter, a separator that separates oil from the water for directing it via a conduit and through said main drain, and thereafter discharged into a conventional septic tank or municipal sewage.

4: The recycled water circulating through said separator is directed via a second pump for keeping the water pressure through a fading water filter, a recycled water line for supplying a tank transferring water via a toilet and laundry, and through from the recycled water feeding system.

5: The recycled water being used for flushing toilet will be directed toward a conduit via said main drain, and thereafter discharged into the conventional septic tank or municipal sewage.

6: The recycled and filtered water circulating through said recuperating return line is directed via a sterilizer before to be pre-heated in turning around a heater tank which is supplied thereby said recuperating return line, and thereafter the recycled water is directed via a recycled hot water line and through each said water inlet with valve supplying each sink, a shower, and tub, and a dishwasher through a booster raising the water temperature when needed for dishwashing.

7: The recuperating tank of the claim 2 has a threaded cap and a conduit with valve for enabling the cleaning operation and draining the surplus of body wastes accumulated onto the walls and in bottom of said recuperating tank via said main drain, and thereafter discharged into the conventional septic tank or municipal sewage.

8: The recuperating tank of the claim 2 or 7 further including an overflow line for removing the surplus of waste water from said recuperating thank via said main drain, and thereafter discharged into the conventional septic tank and municipal sewage.
